(19) United States
(12) Patent Application Publication
(10) Pub. No.: US 2015/0227912 A1
(43) Pub. Date: Aug. 13, 2015

(54) Devices and Methods for Facilitating Face to Face Funds Transfers

(71) Applicant: MASTERCARD INTERNATIONAL INCORPORATED, Purchase, NY (US)

(72) Inventor: Surabhi Bishnoi, London (GB)

(21) Appl. No.: 14/619,618

(22) Filed: Feb. 11, 2015

(30) Foreign Application Priority Data
Feb. 12, 2014 (GB) 1402412.9

(51) Int. Cl. G06Q 20/32; G06Q 20/34

(52) U.S. Cl. CPC G06Q 20/322; G06Q 20/34

(57) ABSTRACT

A device is provided that enables two account holders with associated payment cards to transfer funds between their accounts using their payment cards. The device comprises a payment card reader, communication means for communicating with a payment processing network, and a user interface. The device is configured to receive an input, via the user interface, indicating an amount to be transferred; to obtain data, via the payment card reader, from a first payment card associated with a first account from which funds are to be transferred; to obtain data, via the payment card reader, from a second payment card associated with a second account to which funds are to be transferred; and to initiate a transfer of funds, via the communication means, from the first account to the second account over the payment processing network.

### FIELD

The present disclosure relates generally, but not exclusively, to devices which enable two account holders with associated payment cards to transfer funds between their accounts using their payment cards.

### BACKGROUND

This section provides background information related to the present disclosure which is not necessarily prior art.

The situation often arises where one person wishes to transfer money to another person. At its most basic, one person (the transferor) could hand over the money directly in the form of cash to the other person (the transferee). However, this relies on the transferor having the correct amount of cash on them or the transferee having the correct amount of change. This is often not the case. Moreover, there are security risks associated with carrying cash around on the person.

Another option is for an account holder (the transferor) to transfer funds from their account into the account of another account holder (the transferee) by way of a cheque identifying the transferee and stating the amount of money to be transferred. The use of cheques is declining as many perceive it to be a time-consuming and inefficient way of transferring funds and it can be inconvenient to carry a chequebook. For larger funds transfers, online banking and telephone banking are often used as they safely enable account holders to transfer money electronically, directly into a transferee's account. Such electronic transfers require the transferee's account number and sort code (in the UK, other suitable code(s) for identifying the transferee may also be used) and, for online banking, a card reader is often required for use in verifying the transferor's identity.

However, although funds transfers arranged via telephone or online banking are in many ways more efficient and more secure than using cash or cheques (i.e. no action is required on the part of the recipient of the funds to either deposit the cash in their account or cash the cheque), they require the transferor to telephone their account issuer or to log in to their online banking account in order to arrange a funds transfer. They also need to know the transferee's account number and sort code (or other suitable identification code(s)) in order to arrange a transfer.

Such funds transfers may not be possible where, for example, the transferor does know the required transferee identification codes. It is common for account holders not to know their own account numbers, sort codes or other such identification codes, which are normally much longer than PINs and are used much less frequently by account holders. Additionally, such funds transfers may not be possible where the transferor does not have access to a telephone or the internet.

Where the transferor is in the company of the person to whom they wish to transfer funds, and where the aforementioned issues with cash-based transfers have arisen, one option would be for the transferor to write the transferee a cheque rather than ring up their account issuer or log in to their online banking account. Receiving a cheque would, though, be much less convenient for the transferee and it is increasingly unlikely that the transferor would have a chequebook in hand anyhow.

Accordingly, there is a need to provide a convenient means for an account holder to transfer funds from their account to the account of another account holder, obviating the need for the account numbers, sort codes or other such infrequently-used identification numbers of the transferee to be known, obviating the need for the transferor to telephone their account issuer or log in to their online banking system, obviating the need for the transferee to have to cash a cheque, and obviating the need for the transferor to have a correct amount of cash on them.

### SUMMARY

This section provides a general summary of the disclosure, and is not a comprehensive disclosure of its full scope or all of its features.

The present disclosure generally relates, in part, to a device comprising: a payment card reader; communication means for communicating with a payment processing network; and a user interface, wherein the device is configured to receive an input, via the user interface, indicating an amount to be transferred, obtain data, via the payment card reader, from a first payment card associated with a first account from which funds are to be transferred, obtain data, via the payment card reader, from a second payment card associated with a second account to which funds are to be transferred and initiate a transfer of funds, via the communication means, from the first account to the second account over the payment processing network.

The device may further comprise a display.

The communication means of the device may comprise a wireless communication means.

The communication means may comprise a first communication means for communicating indirectly with the payment processing network via an intermediate device and, the intermediate device may comprise a second communication means for communicating with payment processing network.

The first communication means may comprise a wireless communication means for wirelessly communicating with the intermediate device.

The second communication means may comprise a communication means for wirelessly communicating with the payment processing network.

The first communication means may comprise a means for communicating with the intermediate device via a secure Bluetooth infra-red Wireless, Induction Wireless, NFC, WLAN or Ultra Wideband connection.

The second communication means may comprise a means for communicating with the payment processing network via a telecommunications network.

The intermediate device may be one of a mobile phone, laptop, PC or tablet.

The payment card reader may comprise a slot for physically receiving the card.

The payment card reader may comprise a means for wirelessly accessing the card.

The device may further comprise a second payment card reader such that two payment cards may be read by the device simultaneously.

The device may further comprise a memory; and a processor, wherein the processor is configured to receive an input, via the user interface, indicating an amount to be transferred, obtain data, via the payment card reader, from a first payment card associated with a first account from which funds are to be transferred, obtain data, via the payment card reader, from a second payment card associated with a second account to which funds are to be transferred and initiate a transfer of funds, via the communication means, from the first account to the second account over the payment processing network.

The present disclosure generally relates, in part, to a method of transferring funds between accounts, the method comprising the steps of: receiving an input, at a device, indicating an amount to be transferred; obtaining data, at the device, from a first payment card associated with a first account from which funds are to be transferred; obtaining data, at the device, from a second payment card associated with a second account to which funds are to be transferred; and initiating a transfer, at the device, of funds over a payment processing network.

The step of obtaining data, at the device, from the first payment card may include a first cardholder verification step.

The step of obtaining data, at the device, from the second payment card may include a second cardholder verification step.

The, or each, cardholder verification step may comprise one or more of: verifying a PIN associated with the payment card, and verifying biometric data associated with the payment card.

The steps of obtaining data, at the device, from a first payment card associated with a first account from which funds are to be transferred and obtaining data, at the device, from a second payment card associated with a second account to which funds are to be transferred may be performed simultaneously.

The steps of obtaining data, at the device, from a first payment card associated with a first account from which funds are to be transferred and obtaining data, at the device, from a second payment card associated with a second account to which funds are to be transferred may be performed in sequence.

Advantageously, such a device and method do not require the user to contact their bank directly to arrange a transfer and do not require the user to log in to an online banking system in order to arrange a funds transfer. All that is required are the account details of the respective parties, which can be obtained conveniently via, for example, the insertion of their payments cards into the card reader.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

Embodiments of the present disclosure will now be described, by way of example only, with reference to the accompanying drawings, in which:

FIG. 1 depicts the device of the present disclosure;

FIG. 2 depicts the device of the present disclosure and components of the system within which the device operates; and

FIG. 3 is a flow diagram showing exemplary steps which may be performed by the device of the present disclosure.

### DETAILED DESCRIPTION

Embodiments of the present disclosure will now be discussed with reference to the enclosed figures. However, a person skilled in the art will readily appreciate that the detailed description given herein with respect to these figures are for explanatory purposes only, as embodiments of the present disclosure may extend beyond these embodiments.

In one embodiment there is provided a device which enables the transfer of funds between two account holders. The device obviates the need for the transferor of funds to write a cheque, contact their bank to arrange the transfer of funds, obtain transferee account identification numbers or to have the correct amount of cash on them.

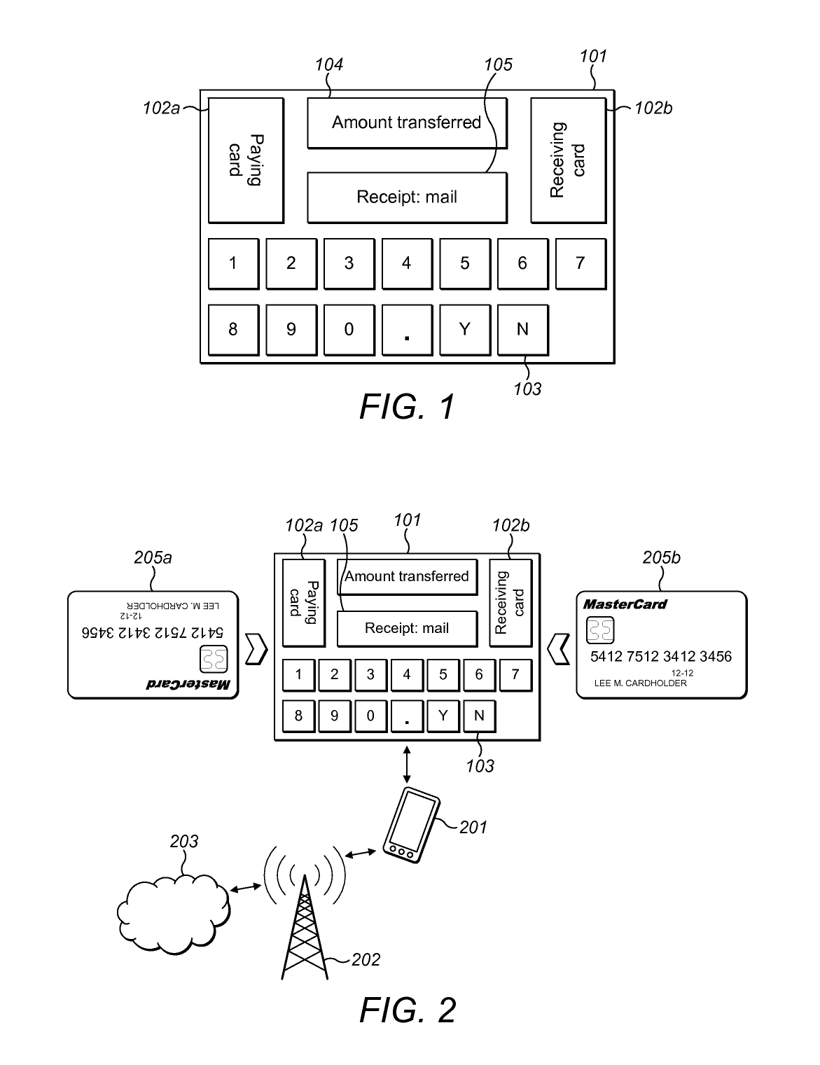

FIG. 1 depicts an example of such a device 101. The device shown comprises two payment card readers 102a and 102b, a user interface 103, a display 104 and an optional receipt generating means 105.

The payment card readers 102a, 102b of device 101 may be in the form of recesses or slots within the device configured to receive and then read the magnetic strip or, where the card is an integrated circuit card (ICC), the chip of the payment card. The card readers 102a and 102b may instead be contactless smart card readers or readers capable of reading other contactless payment devices such as mobile phones or other electronic devices with contactless payment functionality. The card readers 102a and 102b may also combine all of the above features and functionality.

The provision of a pair of card readers 102a, 102b allows the details from two payment cards (typically those of the transferor and the transferee respectively) to be read simultaneously (see FIG. 2). It will be understood that the device 101 may only have one such payment card reader for reading, in turn, the transferor's payment card and the transferee's payment card in either order.

The user interface 103 of the device 101 comprises a suitable means for inputting an amount of funds to be transferred and, optionally, the currency. Suitable means may be, but are not limited to being, a keypad, a touch sensitive keypad or a voice recognition system.

The display 104 of the device 101 displays information such as the inputted amount to be transferred. It may also display instructions to the users of device 101 such as how to follow the method steps outlined below.

Alternatively, the display may be replaced with an audio device, capable of communicating the same information as would be presented by the display 104, but using only sound.

The user interface 103 and display 104 may be combined in the form of a single touch sensitive display (not shown) configured to allow the inputting of an amount to be transferred and/or provide the users of the device with the aforementioned information.

The optional receipt generating means 105 enables contact details to which a receipt can be sent to be entered into the device 101. Suitable contact details include, but are not limited to, an email address or a mobile phone number. The device 101 may then send an email or an SMS confirming the outcome of the transfer of funds.

The receipt generating means 105 may comprise a separate display for displaying the input contact details (as shown). The contact details may be input using the user interface 103. Alternatively, the contact details may be displayed by display 104, in which case no separate display is required.

The device 101 also further comprises a means for communicating with a payment processing network (not shown). This may be a means for directly communicating with the payment processing network or a means for indirectly communicating with the payment processing network via a second, intermediary device 201 with long range communication capabilities (described in detail below).

The device 101 can be used to transfer money between two accounts using only a payment card 205a associated with the transferor's account and a payment card associated 205b associated with the transferee's account (both shown in FIG. 2).

Advantageously, the device does not require the user to contact their bank directly to arrange a transfer and it does not require the user to log in to an online banking system in order to arrange a funds transfer. All that is typically required is the payment card 205a of the transferor and the payment card 205b of the transferee.

In an alternative embodiment, the device 101 may further comprise means for analysing biometric data associated with the transferor in order to verify their identity and, optionally, that of the transferee.

FIG. 2 depicts the example device 101 of FIG. 1, a second device 201, a telecommunications network 202, a payment processing network 203, a transferor card 205a and a transferee card 205b.

The cards 205a and 205b may be standard issue credit/debit/prepaid/charge cards.

The second device 201 may act as an intermediary between the device 101 and the payment processing network 203. The second device 201 may, for example, connect with the device 101 via a suitable secure short range communication means which may be, but is not limited to, one the following: Bluetooth, infra-red Wireless, Induction Wireless, NFC, WLAN or Ultra Wideband.

The second device 201 can connect with the payment processing network 203 via telecommunications network 202.

The telecommunications network 202 may be, but is not limited to being, one of: a mobile network, the internet, a telephone network or a computer network. The second device 201 may be, but is not limited to being, one of: a mobile phone, a laptop, a PC or a tablet. The payment processing network 203 may be any network capable of processing a funds transfer, one such network being the MasterCard™ operated Banknet™.

Alternatively, the device 101 may itself be capable of communicating directly with payment processing network 203 via the telecommunications network 202.

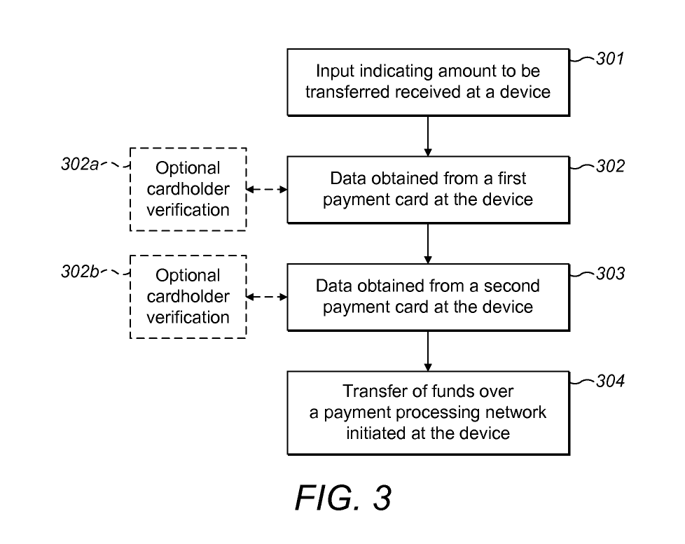

The holder of each card may be required to perform a card holder verification step. This may involve entering a PIN at the device 101. This step will be discussed in greater detail within the context of FIG. 3.

FIG. 3 is a flow diagram showing exemplary steps which may be performed by the device 101, as described above, when the device 101 is used to transfer funds between two accounts.

In step 301, an input is received at the device 101 indicating an amount to be transferred. This input may be received via the user interface 103 and the source of the input may be the transferor of the funds (in a ‘push’ transaction, where the payment is initiated by the transferor) or the transferee (in a ‘pull’ transaction, where the payment is requested by the transferee).

In step 302, data is obtained from a first payment card 205a associated with the transferor's account. This step involves the device 101 reading the card 205a belonging to the transferor.

Step 302a is an optional cardholder verification step for verifying the holder of the first payment card 205a (the transferor). This step may include the transferor inputting a PIN to the device 101 and/or providing biometric data to the device 101 where the device 101 supports such functionality.

In step 303, data is obtained from a second payment card 205b associated with the transferee's account. This step typically involves the device 101 reading the card 205b belonging to the transferee.

Step 303b is an optional card holder verification step for verifying the holder of the second payment card 205b (the transferee). This step may include the transferee inputting a PIN to the device 101 and/or providing biometric data to the device 101 where the device 101 supports such functionality.

Steps 302 and 303 may be performed simultaneously or in reverse order. Also, the input step 301 may be done after either or both of steps 302 and 303.

In one embodiment, the device 101 may be pre-loaded with the transferor's account details, so the step 302 (and 302a) may be omitted. In another embodiment, the transferee's account details may be input to the device 101 via the user interface 103 instead of via the card reader, such that step 303 (and 303a) may be omitted.

In step 304, a transfer for funds is initiated over a payment processing network by the device 101. As discussed above, this may involve the device 101 connecting with the payment processing network 203 directly or via an intermediate device 201 (shown in FIG. 2).

The flow charts and descriptions thereof herein should not be understood to prescribe a fixed order of performing the method steps described therein. Rather, the method steps may be performed in any order that is practicable. Although the present disclosure has been described in connection with specific exemplary embodiments, it should be understood that various changes, substitutions, and alterations apparent to those skilled in the art can be made to the disclosed embodiments without departing from the spirit and scope of the disclosure as set forth in the appended claims.

It should be appreciated that the functions and/or steps described herein, in some embodiments, may be described in computer executable instructions stored on a computer readable media (e.g., in a physical, tangible memory, etc.), and executable by one or more processors. The computer readable media is a non-transitory computer readable storage medium. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Combinations of the above should also be included within the scope of computer-readable media.

It should also be appreciated that one or more aspects of the present disclosure transform a general-purpose computing device into a special-purpose computing device when configured to perform the functions, methods, and/or processes described herein.

With that said, exemplary embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular exemplary embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

The foregoing description of exemplary embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1. A device comprising:
a payment card reader;
communication means for communicating with a payment processing network; and
a user interface,
wherein the device is configured to receive an input, via the user interface, indicating an amount to be transferred, obtain data, via the payment card reader, from a first payment card associated with a first account from which funds are to be transferred, obtain data, via the payment card reader, from a second payment card associated with a second account to which funds are to be transferred and initiate a transfer of funds, via the communication means, from the first account to the second account over the payment processing network.

2. The device of claim 1, further comprising a display.

3. The device of claim 1, wherein the communication means is a wireless communication means.

4. The device of claim 1, wherein the communication means comprises a first communication means for communicating indirectly with the payment processing network via an intermediate device and, wherein the intermediate device comprises a second communication means for communicating with the payment processing network.

5. The device of claim 4, wherein the first communication means comprises a wireless communication means for wirelessly communicating with the intermediate device.

6. The device of claim 5, wherein the second communication means comprises a wireless communication means for wirelessly communicating with the payment processing network.

7. The device of claim 4, wherein the first communication means comprises a means for communicating with the intermediate device via a secure Bluetooth infra-red Wireless, Induction Wireless, NFC, WLAN or Ultra Wideband connection.

8. The device of claim 7, wherein the second communication means comprises a means for communicating with the payment processing network via a telecommunications network.

9. The device of claim 4, wherein the intermediate device is one of a mobile phone, laptop, PC or tablet.

10. The device of claim 1, wherein the payment card reader comprises a slot for physically receiving the card.

11. The device of claim 1, wherein the payment card reader comprises a means for wirelessly accessing the card.

12. The device of claim 1, further comprising a second payment card reader such that two payment cards may be read by the device simultaneously.

13. The device of claim 1, further comprising:
a memory; and
a processor, wherein the processor is configured to receive an input, via the user interface, indicating an amount to be transferred, obtain data, via the payment card reader, from a first payment card associated with a first account from which funds are to be transferred, obtain data, via the payment card reader, from a second payment card associated with a second account to which funds are to be transferred and initiate a transfer of funds, via the communication means, from the first account to the second account over the payment processing network.

14. A method of transferring funds between accounts, the method comprising the steps of:
receiving an input, at a device, indicating an amount to be transferred;
obtaining data, at the device, from a first payment card associated with a first account from which funds are to be transferred;
obtaining data, at the device, from a second payment card associated with a second account to which funds are to be transferred; and
initiating a transfer, at the device, of funds over a payment processing network.

15. The method of claim 14, wherein the step of obtaining data, at the device, from the first payment card includes a first cardholder verification step.

16. The method of claim 15, wherein the step of obtaining data, at the device, from the second payment card includes a second cardholder verification step.

17. The method of claim 16, wherein the first and/or second cardholder verification step comprises one or more of: verifying a PIN associated with the payment card, and verifying biometric data associated with the payment card.

18. The method of claim 14, wherein the steps of obtaining data, at the device, from a first payment card associated with a first account from which funds are to be transferred and obtaining data, at the device, from a second payment card associated with a second account to which funds are to be transferred are performed simultaneously.

19. The method of claim 14, wherein the steps of obtaining data, at the device, from a first payment card associated with a first account from which funds are to be transferred and obtaining data, at the device, from a second payment card associated with a second account to which funds are to be transferred are performed in sequence.
